(19) United States
(12) Patent Application Publication
(10) Pub. No.: US 2025/0138239 A1
(43) Pub. Date: May 1, 2025

(54) METHOD AND INTERMEDIATE PRODUCT FOR PRODUCING A MULTI-CORE FIBRE WITH A MARKER

(71) Applicant: HERAEUS QUARZGLAS GMBH & CO. KG, Hanau (DE)

(72) Inventors: Tobias TIESS, Bitterfeld-Wolfen (DE); Kay SCHUSTER, Bitterfeld-Wolfen (DE); Michael HUENERMANN, Kleinostheim (DE)

(21) Appl. No.: 18/836,954

(22) PCT Filed: Jan. 19, 2023
(86) PCT No.: PCT/EP2023/051174

§ 371 Date: Aug. 8, 2024

(30) Foreign Application Priority Data
Feb. 14, 2022 (EP) 22156510.4

(51) Int. Cl. G02B 6/02; C03B 37/027

(52) U.S. Cl. CPC G02B 6/02395; C03B 37/027

(57) ABSTRACT

A target rod comprises a first glass region extending along the target rod longitudinal axis and a marker region extending along the target rod longitudinal axis and adjacent to the first glass region, which marker region contains the marker element or provides a hollow channel that either forms the marker element or is designed for receiving the marker element, and the semi-finished product comprises the cladding material layer and the target rod.

TECHNICAL BACKGROUND

The present invention relates to a method for producing a multi-core fiber with a marker zone or a pre-form for such a multi-core fiber, said method comprising the formation of a semi-finished product which comprises a glass cladding region made of a cladding glass with a plurality of core glass regions made of a core glass embedded therein, and at least one marker element, the multi-core fiber or the pre-form being obtained by elongation of the semi-finished product, and the production of the glass cladding region comprising a method step in which a cladding material layer is deposited on an outer surface of a target rod having a target rod longitudinal axis using an outside deposition method.

In addition, the invention relates to an intermediate product for producing a multi-core fiber or a pre-form for same.

In multi-core fibers, a plurality of light wave-conducting optical core regions (also referred to below as “signal cores”) are integrated in a common fiber. The signal cores extend along the longitudinal axis of the fiber. They are surrounded by cladding material with a lower refractive index and enable substantially independent light guidance. This fiber design promises a high signal transmission capacity, because different signals, combined in a single optical fiber, can be transmitted simultaneously in each of the spatially separated signal cores. This signal transmission method is also referred to as “spatial multiplexing”, which in particular can increase the data transmission capacity in optical telecommunications. Multi-core fibers are also regarded as a component of fiber optic sensors in measuring and medical technology, and are considered for lighting and imaging purposes in microscopic or endoscopic devices.

### PRIOR ART

Multi-core fibers are produced by elongating a solid pre-form or a group of components. These frequently consist of synthetically produced quartz glass (SiO₂), which may be doped or undoped. The production of synthetic quartz glass comprises, for example, plasma or CVD deposition methods known by the names OVD, VAD, MCVD, PCVD or FCVD methods. A liquid or gaseous silicon-containing starting substance is subjected to a chemical reaction (hydrolysis, pyrolysis or oxidation), and the reaction product—particulate SiO₂—is deposited as a solid from the gas phase on a deposition surface. The starting substance is, for example, silicon tetrachloride (SiCl₄) or a chlorine-free silicon compound, such as a polyalkyl siloxane. The reaction zone is, for example, a furnace, a burner flame or an arc (plasma).

In the so-called “stack and draw” method, core rods and glass cylinders of different diameters are stacked such that they create a relatively high packing density and have a certain degree of symmetry. The cylindrical components are inserted into a sheath tube and are spatially fixed therein. This group is drawn to form the multi-core fiber or is processed further in advance to form a pre-form from which the multi-core fiber is then drawn. This method is described, for example, in U.S. Pat. No. 6,154,594 A.

The “stack-and-draw” method requires a high level of adjustment effort and easily results in errors in dimensional stability and in the introduction of impurities resulting from the large proportion of free component surfaces. In addition, due to differences in the radial packing density, the elongated pre-form often has different radius values in the azimuthal direction, which have to be compensated for by cylindrical grinding.

In the method known from US 2015/0307387 A1, a pre-form for multi-core fibers is produced by drilling through-holes into a rod-shaped base material made of glass, into which core glass rods are subsequently inserted. A hollow glass cladding cylinder in the form of a soot body based on SiO₂ produced according to the OVD method is used as a base body (SiO₂ soot body). In the OVD method, the deposition surface is generally the outer surface of a rod-shaped or tubular deposition mandrel rotating about its longitudinal axis. A substantially cylindrical soot body is deposited by a reversing back and forth movement of the reaction zone. After completion of the deposition process, the deposition mandrel is removed so that a central middle bore remains in the central axis of the cylindrical soot body. Longitudinal bores for receiving the core glass rods are introduced into the hollow glass cladding cylinder. In addition, a further longitudinal bore for receiving a marker element in the form of a marker rod is produced by mechanical drilling in the region of the hollow glass cladding cylinder close to the edge.

When the multi-core fiber is drawn, the marker rod is elongated to form a marker zone. The marker zone serves in particular in the case of symmetrical fiber designs for symmetry breaking in order to identify the signal cores of the multi-core fiber and to be able to clearly assign them in respect of their positions relative to one another and in relation to the fiber central axis. The identification and assignment of the signal cores is necessary, for example, so that two multi-core fibers can be joined together via their end faces by means of conventional splicing methods with low attenuation and with correctly assigned signal cores.

### TECHNICAL PROBLEM

The production of hollow glass cladding cylinders using outside deposition methods, in particular based on the OVD method, is cost-effective in comparison with other manufacturing methods, in particular in comparison with the VAD (vapor phase axial deposition) method. However, it has the disadvantage that, after removal of the deposition mandrel, the central bore remains, which, during collapse, leads to mechanical stresses and to asymmetrical deformations and can destroy the fiber design. In addition, the collapse causes the cross-sectional area of the glass cladding portion to be reduced. These disadvantages can be at least partially eliminated by inserting a filling rod closing the central bore. The filling rod can consist of glass which has substantially the same refractive index and coefficient of thermal expansion as the hollow glass cladding cylinder. However, even with this measure, mechanical stresses on the filling rod arise during the collapse and may necessitate a subsequent tempering of the composite formed of hollow glass cladding cylinder and filling rod.

The marker zone additionally to be inserted into the fiber design should have as small a cross section as possible in order to counteract undesired effects, such as the influence on the signal transmission, stresses induced in the fiber, or the so-called fiber curl. The degree of curvature over a certain length of the fiber is defined as “fiber curl”. The curvature results from thermal stresses which arise during the fiber production. A high “fiber curl” generates optical losses by microbends and makes the low-attenuation splicing of the multi-core fiber more difficult.

In order to minimize these disadvantages, a thin marker zone is sought, which in turn requires the smallest possible diameter of the channel for receiving the marker element in the plane of the hollow glass cladding cylinder. Typically, the channel diameter in the hollow glass cladding cylinder is less than 15 mm, accompanied by a high aspect ratio above 65 (with a hollow cylinder length of about 1 m).

The dimensionally accurate production and exact alignment of such thin channels in a hollow glass cladding cylinder are difficult, even when high-precision drilling machines are used. In addition, it has been shown that cracks are produced increasingly in the channel wall, especially during the drilling of thin channels. The costs for producing the hollow glass cladding cylinder from synthetic quartz glass are great and the loss is particularly painful if it is the small bore for receiving the marker element of all things that leads to the otherwise finished hollow glass cladding cylinder being rejected.

In addition, the cutting and splicing of the multi-core fiber can take place in accordance with the specific requirements in the intended use at any desired position, so that a consistent geometry along the entire fiber length must be familiar in order not to be reliant on measurements. This means that the longitudinal axes of the marker element and the hollow glass cladding cylinder must run as parallel as possible in the plane of the hollow glass cladding cylinder.

The object of the invention is therefore that of specifying a method for producing multi-core fibers with marker zone which uses the cost advantages of the outside deposition method, but reduces the disadvantages and difficulties associated with the filling rod and the marker element, and in which the risk of rejects is also reduced.

In addition, an object of the invention is to provide an intermediate product which is suitable for cost-effective production of a multi-core fiber with marker element which is distinguished in particular by a low fiber curl.

### GENERAL DESCRIPTION OF THE INVENTION

With regard to the method, this object is achieved according to the invention proceeding from the method mentioned at the outset in that the target rod has a first glass region extending along the target rod longitudinal axis and a marker region extending along the target rod longitudinal axis and adjacent to the first glass region, which marker region contains the marker element or provides a hollow channel that either forms the marker element or is designed for receiving the marker element, and the semi-finished product comprises the cladding material layer and the target rod.

The multi-core fiber is obtained by elongating the pre-form or the semi-finished product. The semi-finished product is, for example, a primary pre-form for the multi-core fiber or is a group of components which is drawn directly to form the multi-core fiber or further processed to form a pre-form for the multi-core fiber.

The production of the glass cladding region of the semi-finished product comprises a method step in which a cladding material layer is produced using an outside deposition method. Outside deposition methods are, for example, thermal spraying methods or vapor-phase deposition methods.

In thermal spraying, oxidic or slightly oxidizable silicon-containing or silicon-dioxide-containing starting powders in the form of a fluid mass, such as flowable SiO₂ powder, sol, dispersion or slurry is fed to an energy source, melted therein and spun at high speed onto the outer surface of a deposition mandrel rotating about its longitudinal axis. The energy source is, for example, a combustible gas-oxygen flame, a plasma jet, an arc or a laser beam. The plasma spraying method, which enables a comparatively high energy input and high speeds during spin-coating of the melted starting powder particles, is particularly preferred in this case.

In vapor phase deposition methods, SiO₂ particles are produced by hydrolysis, pyrolysis, or oxidation of a silicon-containing precursor in situ, and these are deposited as SiO₂-containing layer on the outer surface of a deposition mandrel rotating about its longitudinal axis. Examples of this include the OVD method (outside vapor phase deposition) and the POD method (plasma outside deposition). At sufficiently high temperature in the region of the deposition mandrel surface, the SiO₂ particles are directly vitrified, which is also known as “direct vitrification”. In contrast, in what is known as the “soot method” the temperature during deposition of the SiO₂ particles is so low that a porous SiO₂ soot layer is obtained.

The porous SiO₂ soot layer obtained as a cladding material layer in the soot method is vitrified in a separate method step to form a glass cladding region made of transparent quartz glass. In the case of the outside deposition methods with direct glazing and in the thermal spraying method, a vitreous layer is directly obtained as the cladding material layer and forms the glass cladding region of the semi-finished product or at least a part thereof.

The production of the glass cladding region of the semi-finished product using outside deposition methods is cost-effective compared to other production methods.

In the method according to the invention, a target rod is used as the deposition mandrel for the outside deposition method. After completion of the outside deposition method, the target rod remains in the deposited cladding material layer and thus forms a part of the semi-finished product for producing the multi-core fiber. The target rod consists of a vitreous material, which is part of the multi-core fiber. This is a difference from other outside deposition methods in which the deposition mandrel is removed after completion of the outside deposition method, so that a central through-opening remains in the cladding material layer. A subsequent filling of the through-opening with a filling rod is therefore unnecessary and thus the difficulties associated with the filling are also dispensed with in order to ensure the straightness, dimensional stability, and the greatest possible freedom from stress, as well as the failure risks and the outlay for adjustment, time and material.

The target rod has at least one first glass region and a marker region adjacent thereto. The marker region is formed in or on the target rod. The target rod is thus used to insert a marker element into the semi-finished product in addition to the target rod material. In addition to the first glass region, the target rod can have a further glass region or a plurality of glass regions which differ in terms of their chemical composition from the first glass region.

In the target rod, the marker element forms, for example, a hollow channel which can be filled with air, a cylindrical component or a plurality of cylindrical components or with a powder bed, or the marker element is arranged on an outer wall of the target rod and is designed here as (at least one) cylindrical component or as a coating or mass adhering to the outer wall. The hollow channel can also be filled with a marker material after completion of the outside deposition method.

Since the marker element is located in or on the target rod, there is no need to adapt the cladding material layer for the purpose of inserting the marker element, for example by mechanical machining and in particular by generating a bore for receiving the marker element in the cladding material layer. The effort associated with such an adaptation of the cladding material layer and the risk of damage are thus eliminated.

The dimensional stability and the straightness of the target rod are comparatively easy to ensure—if necessary—by mechanical round grinding and/or by an elongation process to which a starting cylinder is subjected in order to elongate therefrom a cylinder strand from which the target rod is produced or from which a plurality of target rods are cut to length. In order to avoid damage to the cylinder strand surface, the elongation process preferably takes place without the use of a shaping tool which acts on the drawn-off cylinder strand.

An axially parallel alignment of the marker element is facilitated in that it adjoins the target rod or the first glass region thereof. Its straightness, which is comparatively simple to achieve, also facilitates the axis-parallel alignment of the marker element. This applies in particular to a particularly preferred procedure in which the marker region is arranged between the first glass region and the glass cladding region.

The component group is thus equipped with a marker element without a separate bore, associated with the risks and difficulties explained above, having to be created therefor in the glass cladding region. At the same time, despite a high aspect ratio, a high accuracy can be ensured which, for example in the semi-finished product, manifests itself in that the axis parallelism of the marker element has a deviation of less than 0.3 mm/m.

The target rod can consist of a single glass cylinder or it can be composed of a plurality of glass cylinders connected to one another. The plurality of glass cylinders can have the same composition or they can differ from one another in their composition. The target rod can consist completely or partially of the cladding glass and/or of the core glass or of another glass and/or other glasses.

The chemical compositions of the first glass region and the adjacent marker region differ from one another. In the multi-core fiber, the marker region forms a continuous line-like marker zone made of a marker material or of air. The marker zone can serve, for example, during splicing for symmetry breaking and for unambiguous identification of the signal cores and their positions relative to one another and with respect to the fiber central axis.

In the cladding material layer, a plurality of core rod bores are produced in the usual way for receiving a core rod each. At least one core rod bore for receiving a core rod can also be introduced into the target rod.

The semi-finished product produced in this way and provided with a plurality of core glass regions is reshaped and either drawn directly to form the multi-core fiber or is consolidated to form a pre-form for the multi-core fiber, wherein the consolidation process can be associated with a simultaneous elongation. The “consolidated pre-form” produced in this way is optionally drawn to form the multi-core fiber or is further processed to form a “secondary pre-form”. Further processing to form the “secondary pre-form” comprises, for example, producing further bores in the glass cladding region and the coating thereof with core glass or with other glasses or the one-time or repeated performance of one or more of the following hot-forming processes: collapse of additional cladding material, collapse, elongation, collapse, and simultaneous elongation. The multi-core fiber is drawn from the secondary pre-form produced by further processing.

The marker element is preferably provided in the form of a cylindrical component made of a marker material or in the form of a layer connected to the target rod or a mass made of the marker material.

In the case of a marker element which contains at least one cylindrical component, this component extends parallel to the target rod and is connected to the target rod at least locally, preferably over the entire component length. The at least one cylindrical marker element component is, for example, a tube and preferably a rod. In the case of a marker element in the form of a tube, the tube wall can contain a material which has a higher viscosity than the cladding glass, so that, during the fiber drawing process, the bore does not collapse completely and is maintained in the finished multi-core fiber as a cavity (“airline”).

In the case of a marker element in the form of a layer or mass connected to the target rod, the layer or mass is arranged, for example, within a hollow channel in the target rod, and it is preferably attached in the region of the outer surface of the target rod.

By attaching the target rod, the marker element benefits very particularly from the straightness and alignment thereof; these properties are quasi transferred to the marker element. The attachment is based, for example, on frictional engagement, integral bonding, and/or form fit between the target rod and the marker element.

The cross-sectional geometry of the target rod is generally circular. It can also have a geometry deviating from the circular shape, such as an oval, elliptical or polygonal geometry. An enveloping circle enveloping the cross-sectional contour has, for example, a diameter in the range of 36 mm to 76 mm.

The target rod is produced, for example, by axial deposition from the gas phase according to the so-called VAD method or according to the OVD method, the central through-opening being subsequently collapsed, or is produced by a pressing method. In the pressing method, a bed of SiO₂ particles is introduced into a mold cavity, and pressure is exerted onto the bed in order to form a compacted blank which is subsequently vitrified to form a glass rod.

In a preferred procedure, the target rod has a recess extending along the target rod longitudinal axis, which recess forms the marker element or in which recess the marker element is arranged. The recess is designed, for example, as a bore through the target rod and preferably as a longitudinal groove (longitudinal channel) on the outer surface of the target rod. The groove-shaped recess is, for example, filled with a cylindrical component made of a marker material or with a particulate marker material. The particulate marker material can have a certain dimensional stability by thermal compaction or by adding binder. The recess thereby ensures a form fit between marker element and target rod. The marker element and target rod can also be connected to one another in advance (i.e., before the deposition of the cladding material layer) by integral bonding, for example by sintering or fusing, which is also referred to here as “consolidation”. Any edges and protrusions can be rounded during consolidation. After consolidation, the marker material preferably fills the recess as completely as possible. In this context, the procedure in which a target rod is provided with a longitudinal groove is particularly preferred. This is because on the one hand a longitudinal groove is particularly easy to manufacture geometrically precisely in the target rod outer surface in comparison to a bore; for example by milling by means of a mechanical milling machine or by laser ablation. On the other hand, the longitudinal groove produced in this way is just as precise and straight as the target rod itself. Furthermore, the depth or the opening width of the longitudinal groove can virtually be as small as desired, for example both less than 15 mm, preferably less than 10 mm and particularly preferably less than 5 mm. The longitudinal groove can be filled with a marker material during the outside deposition method. Geometrically precise marker elements with a small volume can thus be produced in a simple manner, which marker elements have a deviation in their axial orientation of less than 0.3 mm/m in the semi-finished product and accordingly form correspondingly small and highly precise marker zones in the multi-core fiber. The longitudinal groove is filled with the marker material, for example, by inserting a cylindrical component (rod or tube), made from the marker material, or by introducing a bed of marker material particles or by coating the interior of the longitudinal groove with the marker material. The cylindrical component, the inner coating or the bed formed of the marker material can additionally be fixed in the longitudinal groove by fusing.

In a preferred procedure, a fused composite of target rod and marker element is produced by elongating a preliminary product. The preliminary product is present, for example, as a composite of target rod and marker element, or it forms a group of target rod and marker element starting bodies which are not connected to one another or are only locally connected to one another. The preliminary product has greater lateral dimensions than the fused composite to be produced consisting of target rod and marker element. The elongation of the preliminary product on the one hand causes the downscaling of any geometric errors and dimensional deviations, and on the other hand contributes to straightening of the fused composite. The desired fused composite formed of target rod and marker element is cut to length from the elongated fused composite strand for use in multi-core fiber production. In this way, marker elements with small lateral dimensions can be produced even with particularly large aspect ratios with high dimensional stability.

In a particularly preferred method variant, the cladding material layer produced using the outside deposition method is formed as a soot layer based on SiO₂.

The SiO₂ soot layer is obtained by hydrolysis, pyrolysis or oxidation of a silicon-containing starting compound in an oxygen-containing reaction zone and deposition of the SiO₂ particles, formed during this process, on the outer surface of the rotating target rod. The temperature in the region of the target rod outer surface is kept so low here that the deposited cladding material layer does not remain densely vitrified, but rather is porous. This temperature is, for example, in the range of 800° C. and 1250° C., and the specific density is typically in the range of about 0.6 g/cm³ up to 1.8 g/cm³.

The porosity of the SiO₂ cladding material layer allows subsequent removal of the OH groups contained therein by treatment in a drying atmosphere and doping with a gaseous dopant, for example fluorine.

The soot layer is preferably vitrified by heating to a vitrification temperature.

The vitrification takes place, for example, by heating in a sintering furnace to a temperature above 1400° C. under vacuum and/or in a helium atmosphere. A cladding material layer formed of transparent quartz glass is thus obtained.

In one procedure, prior to vitrification, the soot layer is subjected to a doping treatment in an atmosphere containing a dopant and/or to a dehydration treatment in a halogen-containing atmosphere or under vacuum.

The doping or dehydration treatment can directly precede the vitrification process and can take place in the same furnace. The dehydration treatment comprises, for example, helium purging followed by a hot chlorination process at a temperature around 900° C. In the alternative drying under vacuum, the SiO₂ soot layer is treated at a temperature of at least 1150° C. under a pressure of 0.1 mbar or less in a vacuum furnace. The hydroxyl group concentration is thereby lowered to less than 1 wt. ppm.

The doping treatment comprises, for example, the loading of the SiO₂ soot layer with fluorine, in that the target rod together with the cladding material layer is introduced into a doping furnace and is exposed to an atmosphere at a temperature above 980° C., which atmosphere contains fluorine-containing substances, such as, for example, silicon tetrachloride. In this way, a fluorine loading of the SiO₂ soot layer enables a mean fluorine content of at least 1500 wt. ppm after the consolidation, for example.

In a preferred method variant, the core rod bores for receiving core glass rods in the cladding material layer are produced after vitrification of the soot layer.

The lower density of the cladding material layer formed from SiO₂ soot compared to dense quartz glass facilitates the production of bores for receiving core glass rods. Two or more, for example four to seven, longitudinal bores (core rod bores) are made in the cladding material layer in a conventional manner, the longitudinal axes of which run in parallel with the target rod longitudinal axis. The core rod bores are through-bores or blind bores and serve to receive at least one core rod made from the core glass in each case.

Viewed in the radial direction, the composition of the core glass is uniformly homogeneous or changes gradually or in stages. It differs from that of the cladding glass in such a way that light guidance in the core glass region is ensured. In the simplest case, all core rods have the same dimensions and consist of the same core glass. However, the core rods can also differ in terms of their dimensions and/or in the composition of the corresponding core glass.

In order to minimize the risk of damage to the core rods, the core rods are inserted into the core rod bores preferably after vitrification of the porous cladding material layer and the formation of the glass cladding region from transparent quartz glass.

The marker element forms an air-filled, elongate hollow channel or contains a marker material which preferably differs from the adjacent cladding glass and/or from the adjacent first glass region of the target rod in at least one physical and/or chemical property, the property preferably being selected from: refractive index, color, fluorescence, and/or specific glass density. The property (or the properties) which distinguish(es) the marker element from the glasses of the component group have an impact in particular on the visual appearance of the marker element and is/are preferably detectable by means of an optical sensor. Just like the glass filler material, for example, as well, the glass composition of a marker glass can be based on quartz glass. The refractive index of quartz glass can be changed by doping. For example, doping a marker quartz glass with fluorine causes a reduction in the refractive index with respect to undoped quartz glass. Incorporating carbon into the marker quartz glass can lead to a black coloration. Depending on the oxidation state, doping the marker quartz glass with titanium causes a gray-blue coloration. Doping the marker quartz glass with rare earth metals or germanium oxide manifests itself in fluorescence at dopant-specific wavelengths. The specific glass density of the marker element can be changed by pores and manifests itself in a reduction of the optical transparency with respect to bubble-free glass.

In a preferred procedure, the production of the component group comprises the following method steps:
(a) providing the target rod comprising the marker region,
(b) providing a plurality of core rods containing a core glass,
(c) depositing the cladding material layer on the outer surface of the target rod using of the outside deposition method,
(d) generating core rod bores at least in the cladding material layer and optionally in the first glass region of the target rod, and
(e) inserting the core rods into the core rod bores.

The semi-finished product produced in this way comprises the target rod with the at least one marker element and the cladding material layer produced thereon, and the core rods. The list numbers (a) to (d) do not provide a sequence of the method steps. Core rods of the semi-finished product are also referred to here as core rods if they are already fused in their corresponding core rod bore.

In a preferred method variant, the marker region is formed as a hollow channel, wherein a cylindrical marker element is inserted into the hollow channel before or after the core rods are inserted into the core rod bores.

With regard to the intermediate product for producing a multi-core fiber or a pre-form for same, the above-stated technical problem is solved in accordance with the invention in that said intermediate product comprises a target rod made of glass, a marker element formed on or in the target rod, and a cladding material layer containing SiO₂ soot, said cladding material surrounding the target rod and the marker element and being connected to the target rod in a frictionally engaged, form-fitting and/or integrally bonded manner.

The intermediate product according to the invention can occur as such in the context of the production of a multi-core fiber or the production of a pre-form for the multi-core fiber on the basis of the method according to the invention. For this application, it is a particularly preferred intermediate product.

The intermediate product is a cylindrical joining composite, comprising a cladding material layer with a central region which is covered by a target rod made of glass, and is formed on or in the at least one marker element. The cladding material layer is present as a porous soot layer based on SiO₂. It is produced by an outside deposition method (OVD method) and forms a glass cladding region made of a cladding glass in the final multi-core fiber.

The target rod extends in the cylinder longitudinal axis and forms the central volume region of the cylinder. The central volume region also includes the at least one marker element, which adjoins a first glass region of the target rod.

In embodiments in which the chemical composition of the first glass region of the target rod corresponds to that of the cladding glass of the multi-core fiber, the corresponding volume region in the multi-core fiber forms a part of the optical cladding. In embodiments in which the chemical compositions of the first glass region of the target rod and of the cladding glass of the multi-core fiber differ from one another, an additional function can be added to the target rod in the multi-core fiber, for example it can act as a “stress zone” which generates and/or compensates for compressive or tensile stresses within the fiber, acting in the radial direction. The target rod can be in one-piece or can consist of a plurality of cylinders running in parallel. In addition to the first glass region, it can have a further glass region or a plurality of glass regions which differ in terms of their chemical composition from the first glass region. In particular, the target rod can contain at least one core glass region, wherein the core glass region forms a signal core in the final multi-core fiber.

The target rod is used to provide a marker element made of marker glass in addition to the first glass region. The marker element is present in the intermediate product, for example, as an elongate cavity or as a consolidated or non-consolidated component made of a marker material or as a coating of such a component with the marker material, and in the multi-core fiber forms a continuous line-like marker zone formed of the marker material or an air-filled hollow channel. The marker element is arranged in or on the target rod. It is located, for example, in a hollow channel which extends parallel to the cylinder longitudinal axis, or it is attached to the outer surface of the target rod. Since the marker element is located in or on the target rod, but not completely within the cladding material layer produced by outside deposition method, there is no need to adapt this cladding material layer for the purpose of inserting the marker element, for example by mechanical machining and in particular by generating a separate bore for receiving the marker element in the cladding material layer. The risk of damage associated with such an adaptation of the cladding material layer is thus eliminated.

The dimensional stability and the straightness of the target rod can be ensured by simple measures. The measures include, for example, a mechanical processing of the target rod and/or an elongation process. The mechanical machining can optionally be an outside machining method, which is generally significantly less complex than an inside machining method.

An axially parallel alignment of the marker element is facilitated in that it adjoins the target rod. The straightness of the target rod, which is comparatively simple to achieve, also facilitates the axis-parallel alignment of the marker element. This applies in particular to a particularly preferred embodiment in which the marker element is arranged between the first glass region of the target rod and the glass cladding region.

The intermediate product is thus equipped with a marker element, for which no separate bore region of the cladding material layer-associated with the risks and difficulties explained above—had to be produced. At the same time, despite a high aspect ratio, a high accuracy can be ensured which, for example in the intermediate product, manifests itself in that the axis parallelism of the marker element has a deviation of less than 0.3 mm/m.

The target rod can consist of a single glass cylinder or it can be composed of a plurality of glass cylinders connected to one another. The plurality of glass cylinders can have the same composition or they can differ from one another in their composition. The target rod can consist completely or partially of the cladding glass or of the core glass or of another glass. The target rod can, for example, have a central core made of the core glass, which central core is surrounded by a cladding region made of the cladding glass.

The marker element is present, for example, as a rod which extends parallel to the target rod. In a further embodiment, the marker element is present as a layer of a marker material which is attached in a hollow channel in the target rod or in the region of the outer surface of the target rod. Here too, the marker element layer and the target rod can optionally also be present in consolidated, i.e., fused-together, form.

The marker element extends along the target rod longitudinal axis preferably over its entire length, and it can be attached locally, but preferably continuously, to the target rod. By attachment to the target rod, the marker element benefits from the straightness and alignment thereof; these properties are quasi transferred to the marker element. The attachment is based, for example, on frictional engagement, integral bonding, and/or form fit between the target rod and the marker element.

The marker element is preferably designed in the form of a cylindrical component made of a marker material or in the form of a layer connected to the target rod or mass made of the marker material. The at least one cylindrical marker element component is, for example, a tube and preferably a rod. In the case of a marker element in the form of a tube, the tube wall can contain a material which has a higher viscosity than the cladding glass, so that, during the fiber drawing process, the bore does not collapse completely and is maintained in the finished multi-core fiber as a cavity (“airline”).

The cross-sectional geometry of the target rod is generally circular. It can also have a geometry deviating from the circular shape, such as an oval, elliptical or polygonal geometry. An enveloping circle enveloping the cross-sectional contour has, for example, a diameter in the range of 36 mm to 76 mm.

In a preferred embodiment, the target rod has a recess extending along the target rod longitudinal axis, which recess forms the marker element or in which the marker element is arranged.

The recess is designed preferably as a bore through the target rod or as a longitudinal groove (longitudinal channel) on the outer surface of the target rod. It forms an air-filled hollow channel or is filled, for example, with a cylindrical component made of a marker material or with a particulate marker material. The particulate marker material can have a certain dimensional stability by part compaction or addition of binder. The marker material fills the recess as completely as possible. The recess thereby ensures a form fit between marker element and target rod. The marker element and target rod can also be connected to one another in advance (i.e., before the production of the cladding material layer) by integral bonding, for example by sintering together or fusing.

In this context, the embodiment in which a target rod is provided with a longitudinal groove is particularly preferred. This is because on the one hand a longitudinal groove is particularly easy to manufacture in the target rod outer surface in comparison to a bore; for example by milling by means of a mechanical milling machine or by laser ablation. On the other hand, the longitudinal groove produced in this way is just as precise and straight as the target rod itself. Furthermore, the depth or the opening width of the longitudinal groove can virtually be as small as desired, for example both less than 15 mm, preferably less than 10 mm and particularly preferably less than 5 mm. Geometrically precise marker elements with a small volume can thereby be produced in a simple manner, which marker elements have a deviation in their axial orientation of less than 0.3 mm/m in the intermediate product and accordingly form correspondingly small and highly precise marker zones in the multi-core fiber.

The longitudinal groove is filled with the marker material, for example, by inserting a cylindrical component (rod or tube), made from the marker material, or by introducing a bed of marker material particles or by coating the interior of the longitudinal groove with the marker material. The cylindrical component, the inner coating or the bed formed of the marker material can additionally be fixed in the longitudinal groove by fusing.

The marker element forms an air-filled, elongate hollow space (channel) or channel or contains a marker material which preferably differs from the adjacent first glass region of the target rod and/or from the cladding glass obtained by vitrification of the cladding material layer of the intermediate product in at least one physical and/or chemical property, the property being selected from: refractive index, color, fluorescence, and/or specific glass density.

On the basis of the method according to the invention or using the intermediate according to the invention, a multi-core fiber is obtained which has a plurality of signal cores and which is traversed by at least one continuous line-like marker zone. The marker zone serves for symmetry breaking and to clearly identify the signal cores and their positions relative to one another and with respect to the fiber central axis.

### Definitions and Measurement Methods

Individual terms in the above description are further defined below. The definitions are part of the description of the invention. For terms and measuring methods that are not specifically defined in the description, the interpretation according to the International Telecommunication Union (ITU) are relevant. In the event of an inconsistency between one of the following definitions and the rest of the description, the statements made elsewhere in the description take precedence.

### Cladding Glass/Glass Cladding Region

The glass cladding region contains a cladding glass. At least a part of the glass cladding region is produced by means of an outside deposition method. Core glass regions designed for signal transmission are produced in the glass cladding region. The cladding glass consists, for example, of undoped quartz glass, or it contains at least one dopant that decreases the refractive index of quartz glass. Fluorine and boron are dopants which can lower the refractive index of quartz glass.

### Core Rods/Core Glass Region

The core rods contain a core glass having a homogeneous or non-homogeneous refractive index profile in the radial direction. The core glass of each of the core rods forms a core glass region. The core rods can contain a region made of a core glass having a comparatively high refractive index and at least one further region made of another glass having a comparatively low refractive index; for example a quartz glass doped with fluorine and/or chlorine. The glass having the highest refractive index is generally located in the central axis of the core rod. It consists, for example, of quartz glass, to which at least one dopant is added to increase the refractive index. In the multi-core fiber, the core rod forms at least one signal core in which the signal to be transmitted is mainly transported. The signal core can adjoin other glass regions with a smaller refractive index which have also been provided by the core rod.

### Target Rod

The target rod has at least one first glass region and a marker region adjacent thereto, which is formed in or on the target rod. In addition to the first glass region, it can have a further glass region or a plurality of glass regions which differ in terms of their chemical composition from the first glass region. The target rod consists of glass, which is part of the multi-core fiber. In particular, the target rod can have a glass region which serves as signal core in the final multi-core fiber. The composition of the first glass region can correspond to that of the cladding glass or can deviate from that of the cladding glass in order to impress an additional property on the multi-core fiber.

The target rod serves as a deposition mandrel for carrying out an outside deposition method by means of which a cladding material layer is produced from the target rod. The cladding material layer consists of quartz glass or it is completely or partially present as an SiO₂ soot layer. The target rod thus serves to insert a marker element into the region of the cladding material layer close to the axis, in addition to the target rod material.

### Marker Element/Marker Material/Marker Glass

The marker element contains air and/or a marker material; in particular at least one marker glass. The chemical composition of the marker material differs from that of the adjacent first target rod glass region that it adjoins, and/or the density of the marker material differs from that of the cladding glass and the first target rod glass region. The marker element is present in the semi-finished product as a component or as a layer or mass on a component and forms an optically detectable marker zone in the multi-core fiber.

### Component Group/Consolidated Pre-Form/Secondary Pre-Form/Semi-Finished Product/Intermediate Product

The “component group” comprises the target rod with the at least one marker element and the cladding material layer deposited on the target rod with core rod bores into which one core rod in each case is inserted. By fixing the core rods in the core rod bores, for example by narrowing a hollow glass cladding cylinder end or by collapsing and fusing, a “pre-form” is obtained which is also referred to here as a “consolidated pre-form”. The component group or the (consolidated) pre-form is elongated to form a “secondary pre-form”, or to directly form the multi-core fiber. The term “semi-finished product” here subsumes the component group, the consolidated pre-form and the secondary pre-form. A cylindrical joining composite is referred to as an intermediate product, which is a target rod made of glass, a marker element, and an SiO₂ soot-containing cladding material layer which surrounds the target rod and the marker element.

### Quartz Glass

Quartz glass here is highly siliceous glass with an SiO₂ content of at least 80 mol %, preferably at least 90 mol %. The quartz glass is undoped or contains one or more dopants. It is, for example, a melted product from naturally occurring SiO₂ raw material (natural quartz glass), or it is synthetically produced (synthetic quartz glass), or consists of mixtures of these quartz glass types. Synthetic, transparent quartz glass is obtained for example by flame hydrolysis or oxidation of synthetically produced silicon compounds, by polycondensation of organic silicon compounds according to what is referred to as the sol-gel method, or by hydrolysis and precipitation of inorganic silicon compounds in a liquid.

### Consolidation/Fusing/Vitrification/Collapse

When components or an SiO₂ mass of glass are referred to, fusing is understood to mean that the components or the SiO₂ mass are fused to one another on a contact surface. Fusing takes place by heating the components or the SiO₂ mass at least in the region of the contact surface by means of a heat source, such as a furnace, a burner, or a laser. During collapse, gaps between the components are closed. Vitrification describes the hot process for transferring porous soot material into dense glass. The consolidation can comprise fusing, vitrification, and collapse processes. The result is thermally compacted, easy-to-handle semi-finished product, such as a pre-form or a component group firmly joined by fusing.

### Position Indications: Top/Bottom

These indications relate to positions during the elongation process and/or during the fiber drawing process. “Bottom” denotes the position in the direction of the drawing process; “top” denotes the position counter to the direction of the drawing process.

### Cross-Section

The section taken perpendicular to the longitudinal direction/longitudinal axis.

### Longitudinal Section

A section taken parallel to the longitudinal direction/longitudinal axis.

### Bore

The terms “bore”, “central bore”, “inner bore” or “longitudinal bore” denote holes having a cylindrical or otherwise any inner geometry. They are produced, for example, by a drilling process or they are produced by depositing a material layer on the outer surface of a mandrel by means of a deposition process or a pressing process and then removing the mandrel.

### Axis-Parallel Alignment/Axis Parallelism

The reference axis is in each case the longitudinal axis of the semi-finished product, the pre-form or the central axis of the multi-core fiber.

### EXEMPLARY EMBODIMENT

The invention is explained in more detail below with reference to an exemplary embodiment and a drawing. In detail, in a schematic representation,

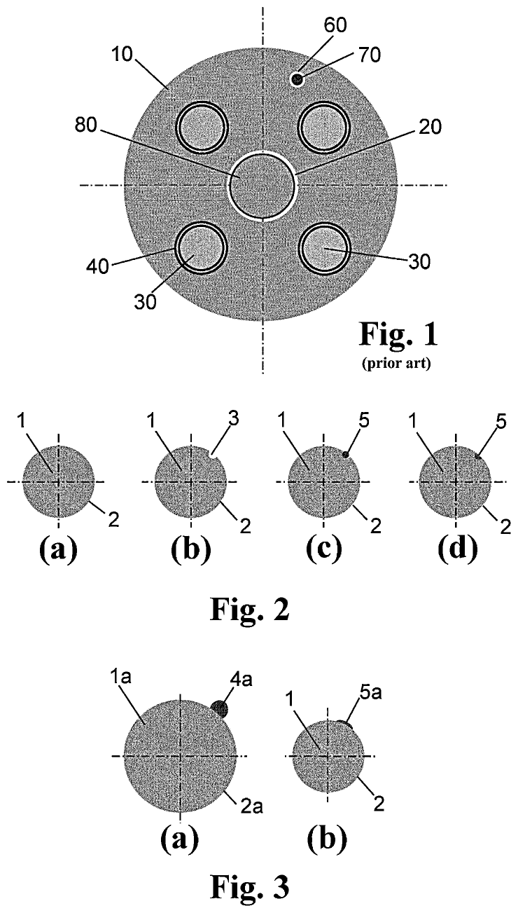

FIG. 1 shows a cross section of a semi-finished product for the production of a multi-core fiber with a hollow glass cladding cylinder, core rods and a marker element according to the prior art,

FIG. 2 shows processing steps (a) to (d) in a first method variant for producing a target rod with marker element for use as a deposition mandrel in an outside deposition method,

FIG. 3 shows processing steps (a) and (b) in a second method variant for producing a target rod with marker element for use as a deposition mandrel in an outside deposition method,

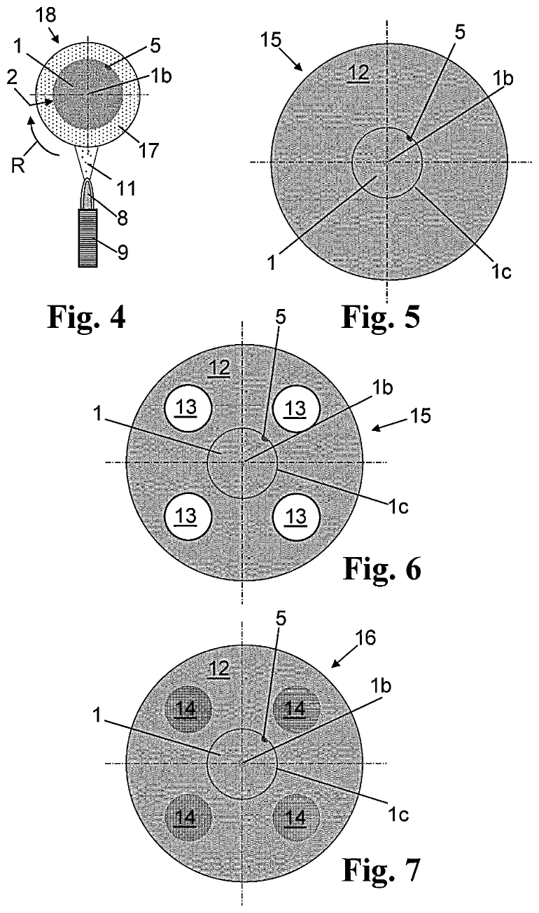

FIG. 4 shows the deposition of a soot layer on the target rod including marker element from FIG. 1,

FIG. 5 shows the component composite on the target rod including marker element and vitrified soot layer,

FIG. 6 shows a cross section of the component composite from FIG. 5 after the production of longitudinal bores,

FIG. 7 shows a consolidated pre-form of the component composite from FIG. 6 with core rods inserted and fused into the longitudinal bores, and

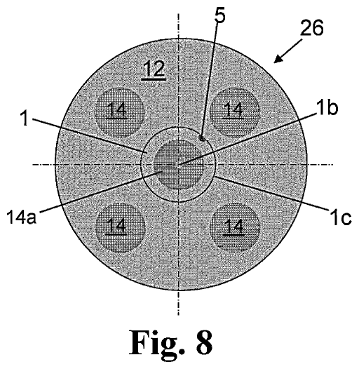

FIG. 8 shows a further embodiment of a consolidated pre-form in cross section.

FIG. 1 schematically shows a cross section of a hollow cylinder 1, made of a cladding glass according to the prior art, which serves as a base body for the production of a multi-core fiber. The hollow cylinder 10 is produced in a known manner using the OVD method. In this method, SiO₂ soot particles are deposited from the gas phase on the outer surface of a cylindrical deposition mandrel rotating about its longitudinal axis, so that an SiO₂ soot body forms on the outer surface of the deposition mandrel. After completion of the deposition process, the deposition mandrel is removed so that an inner bore 20 remains. The SiO₂ soot body is subsequently vitrified to form the hollow cylinder 10. Four longitudinal bores 40 for receiving a core rod 30 each and a further, smaller longitudinal bore 60 for receiving a marker rod 70 are introduced into the wall of the hollow cylinder 10. During consolidation of this component group, a filling rod 80 is inserted into the central bore 20, which filling rod is made of the same material as the hollow-cylinder cladding glass, for example.

The plurality of longitudinal bores (40; 60) in the hollow-cylinder cladding glass is associated with high effort and risk of failure. In particular when producing the smaller longitudinal bore 60 for receiving the marker rod 70, there may easily be unacceptable deviations from the axial parallelism and cracks may form at the bore inner wall, which may lead to failure of the hollow cylinder 1 produced in a complicated manner. The filling and collapsing of the central bore 20 and the customized production of the filling rod 80 are also associated with effort and risk of failure and can easily lead to dimensional deviations. These disadvantages avoid the method according to the invention, which is explained below with reference to FIGS. 2 to 8.

FIG. 2 and FIG. 3 show schematically method steps for preparing a target rod 1 with a marker element 5 or 5a.

The target rod 1 schematically shown in FIG. 2a consists of synthetically produced, non-doped quartz glass which is commercially available under the designation F300. Known techniques are suitable for this purpose, such as, for example, VAD methods (vapor phase axial deposition), OVD methods (outside vapor deposition) or MCVD methods (modified chemical vapor deposition) or powder pressing methods. It serves as a deposition mandrel in an OVD outside deposition method, which is explained further below with reference to FIG. 4. The target rod 1 has a length of approximately 1800 mm and an outer diameter set by round grinding to approximately 42 mm. Possible disturbances of the outer surface 2 and inflections are eliminated by the circular grinding. Alternatively or additionally, the diameter adaptation and surface improvement are achieved by elongation in a tool-free elongation process.

FIG. 2b shows that a longitudinal groove 3 has been milled into the outer surface of the target rod 1. The longitudinal groove 3 extends over the entire length of the target rod 1. It has a U-shape with a rounded bottom and straight side walls. Their opening width and the depth are 6 mm in each case. In a subsequent method step, a hollow channel which forms a marker element within the meaning of the invention can be produced from the longitudinal groove 3.

FIG. 2c shows the longitudinal groove 3 with a marker rod 4 inserted therein. The marker rod 4 has a diameter of 5 mm. It consists of synthetically produced quartz glass doped with fluorine and can be obtained commercially under the name F320. Both the viscosity and the refractive index of the fluorine-doped quartz glass of the marker rod 4 are smaller than in the undoped quartz glass of which the target rod 1 consists. The marker rod 4 is obtained by elongating a starting cylinder made of F320 quartz glass in a tool-free method. It has a smooth surface generated in the molten mass and is characterized by high dimensional stability and straightness so that it can be inserted into the narrow longitudinal groove 3 without difficulty and with a precise fit.

The marker rod 4 inserted into the longitudinal groove 3 is heated over its entire length by means of a burner, so that the fluorine-doped quartz glass softens and deforms as a result of its comparatively low viscosity. FIG. 2d shows the resulting marker glass mass 5 after softening, deformation and fusing with the target rod 1. The glass volume of the former marker rod 4 is matched to the inner volume of the longitudinal groove 3 such that the marker glass mass 5 just completely fills the longitudinal groove 3.

In the alternative procedure shown in FIG. 3, the production of a longitudinal groove is omitted on the one hand, and on the other hand the composite of target rod 1 and marker element 5a is produced on the basis of an upstream elongation process. A starting or preliminary product for the elongation process is on the one hand a target rod starting cylinder 1a made of undoped quartz glass (F300) having a diameter of 63 mm and a length of 800 mm, and a non-round starting marker rod 4a, in which a peripheral portion of the outer surface is flat or slightly concave (inwardly bent) in cross section, as is indicated in FIG. 3a. The starting marker rod 4a consists of a quartz glass doped with fluorine (F320) and has a diameter of 8 mm. The starting marker rod 4a is fused to the starting target rod 1a in parallel axis alignment, wherein the mentioned peripheral portion rests on the outer surface 2a of said target rod. During elongation, the composite of starting target rod 1a and marker rod 4a is drawn to a length of 1800 mm. In this case, the starting cylinders (1a; 4a) fuse further with one another and the low-viscosity quartz glass of the marker rod 4a flows out slightly on the target rod lateral surface 2 and, after cooling, forms a flat glass bead 5a which is fixedly connected to the outer surface 2 of the target rod 1. This is shown schematically in FIG. 3b. On the one hand, the elongation process brings about the downscaling of any geometry errors and dimensional deviations in the starting cylinders (1a; 4a) and, on the other hand, it directs the final melt composite (1; 5a) straight ahead.

FIG. 4 schematically shows the use of the target rod 1 prepared in this way and filled with the marker glass mass 5 as a deposition mandrel in an OVD outside deposition method. A high-purity SiO₂ starting material, for example silicon tetrachloride, is fed here to a deposition burner 9 and a burner flame 8, in which it is converted to solid SiO₂ particles 11. These SiO₂ particles 11 are deposited from the gas phase on the outer surface 2 of the target rod 1, prepared about its longitudinal axis 1b (directional arrow R), the deposition burner 9 executing a reversing back-and-forth movement along the target rod longitudinal axis 1b (this runs, in the cross-sectional representation of FIG. 4, perpendicular to the sheet plane). An SiO₂ soot layer 17 forms on the outer surface 2 of the target rod 1. The intermediate product 18 obtained after completion of the OVD outside deposition method comprises a cylindrical joining composite formed of the target rod 1, the marker glass mass 5, and the SiO₂ soot layer 17, which surrounds the target rod 1 and the marker glass mass 5. The intermediate product 17 is subjected to a dehydration treatment in a chlorine-containing atmosphere at a temperature of 850° C., and immediately thereafter the SiO₂ soot layer 17 is vitrified under vacuum at a temperature of 1450° C. FIG. 5 shows the composite 15, obtained thereafter, formed from target rod 1, including the marker glass mass 5 and the glass cladding region 12 formed of undoped, synthetically produced quartz glass and obtained after consolidation of the SiO₂ soot layer. The dashed circular line 12c represents the circumference of the target rod 1. The outer diameter of the composite 15 is set to a value of 200 mm by external round grinding. The glass cladding region 12 extends along the outer surface 2 of the target rod 1 and has a usable length of about 1500 mm minus rounded end caps.

FIG. 6 shows the composite 15 formed from glass cladding layer 12 and prepared target rod 1 after, in the glass cladding region 12, four bores 13 have been generated in a predetermined (here quadratic) configuration by mechanical drilling in the direction of the target rod longitudinal axis 1b. The bores 13 serve to receive core rods 14 (FIG. 7) and have a diameter of 30 mm. The bores 13 extend through the entire usable length of the glass cladding region 12 (through-bores). In an alternative embodiment, the bores are designed as blind bores.

Moreover, four core rods 14 made of Ge-doped quartz glass with a length of about 1500 mm and an outer diameter of about 28 mm are produced. Known techniques are also suitable for this purpose, for example the MCVD (modified chemical vapor deposition) method.

The core rods 14 are inserted into the bores 12. The component group formed of the composite 15 and the core rods 14 is then heated, so that the annular gaps around the core rods 14 are closed and all components of the group are fused together. FIG. 7 schematically shows the thus consolidated pre-form 16, which is composed of the composite 15 of target rod 1, marker glass mass 5, and glass cladding region 12 and also the core rods 14.

The consolidated pre-form 16 is subsequently elongated to form a secondary pre-form. In this case, the pre-form 16 is held in an elongation device by means of a holder with the target rod longitudinal axis 1b vertically aligned. The secondary pre-form produced in this way is finally drawn to form a multi-core fiber in a conventional manner in a drawing device.

In this exemplary embodiment, the marker element is present as a marker glass mass 5 which has been produced by reshaping the original marker rod 4 within the longitudinal groove 3. In an alternative procedure, a capillary is inserted into the longitudinal groove 3 during the outside deposition method. During the subsequent consolidation processes, the complete collapse of the capillary is prevented by creating and maintaining an overpressure in it. In this way, a cavity is produced which extends along the longitudinal axis 1b, and which is present in the multi-core fiber as an air-filled hollow channel. The hollow channel can serve as a marker zone, since the refractive index of air differs significantly from that of the cladding glass.

Apart from the smaller radial dimensions, the cross-section of the multi-core fiber substantially corresponds to the cross-section of the consolidated pre-form 16. The core glass regions (14) of the former core rods form signal cores which extend along the fiber longitudinal axis, the former target rod (1) forms a part of the glass cladding region, and the former marker element (5) forms a visually easily detectable marker zone. The marker zone (5) is distinguished by a small size so that it applies a low stress to the multi-core fiber during the fiber drawing process and consequently a low fiber curl is established.

In contrast to FIG. 7, in the embodiment shown in FIG. 8 of a consolidated pre-form 26 for a multi-core fiber the center of the target rod 1 is occupied by a core rod 14a. The bore for receiving the core rod 14a is produced in and along the target rod longitudinal axis 1b and in one operation with the other core rod bores 13 (FIG. 6) after vitrification of the soot layer. The diameter of all core rods 14, 14a is the same. The former target rod 1 accordingly has a core glass region which is surrounded by a glass cladding region adjoined, in turn, by the marker zone 5.

1. A method for producing a multi-core fiber with a marker zone or a pre-form for such a multi-core fiber, comprising the formation of a semi-finished product which comprises a glass cladding region made of a cladding glass with a plurality of core glass regions made of a core glass embedded therein, and at least one marker element, the multi-core fiber or the pre-form being obtained by elongation of the semi-finished product, and the production of the glass cladding region comprising a method step in which a cladding material layer is deposited on an outer surface of a target rod having a target rod longitudinal axis using an outside deposition method, wherein the target rod comprises a first glass region extending along the target rod longitudinal axis, and a marker region extending along the target rod longitudinal axis and adjacent to the first glass region, which marker region contains the marker element or provides a hollow channel which either forms the marker element or is designed to receive the marker element, and in that the semi-finished product comprises the cladding material layer and the target rod.

2. The method according to claim 1, wherein the marker region is arranged between the first glass region and the glass cladding region.

3. The method according to claim 1, wherein the marker element forms at least one cylindrical component or a layer or mass connected to the target rod.

4. The method according to claim 3, wherein the target rod comprises a recess extending along the target rod longitudinal axis, which recess forms the marker element or in which recess the marker element is arranged.

5. The method according to claim 4, wherein the recess comprises a longitudinal groove in the outer surface of the target rod.

6. The method according to claim 3, wherein the marker element is attached to the target rod before the outside deposition method is carried out.

7. The method according to claim 1, wherein the cladding material layer produced using the outside deposition method is formed as a soot layer based on SiO₂.

8. The method according to claim 7, wherein the soot layer is vitrified by heating to a vitrification temperature.

9. The method according to claim 8, wherein, prior to vitrification, the soot layer is subjected to a doping treatment in an atmosphere containing at least one dopant and/or to a dehydration treatment in a halogen-containing atmosphere or under vacuum.

10. The method according to claim 7, wherein core rod bores for receiving core glass rods are produced after vitrification of the soot layer.

11. The method according to claim 1, wherein the marker element is designed as a hollow channel, or in that it contains a marker material which differs from the adjacent cladding glass and/or from the adjacent first glass region of the target rod in at least one physical and/or chemical property, the property being selected from: refractive index, color, fluorescence, and/or specific glass density.

12. The method according to claim 1, wherein the production of the semi-finished product comprises the following method steps:
(a) providing the target rod comprising the marker region,
(b) providing a plurality of core rods containing a core glass,
(c) depositing the cladding material layer on the outer surface of the target rod using the outside deposition method,
(d) generating core rod bores at least in the cladding material layer and optionally in the first glass region of the target rod, and
(e) inserting the core rods into the core rod bores.

13. The method according to claim 12, wherein the marker region is designed as a hollow channel, and in that a cylindrical marker element is inserted into the hollow channel before or after insertion of the core rods.

14. An intermediate product for producing a multi-core fiber or a pre-form for same, comprising a target rod made of glass, a marker element formed on or in the target rod, and a cladding material layer containing SiO₂ soot, said layer surrounding the target rod and the marker element and being connected to the target rod in a frictionally engaged, form-fitting and/or integrally bonded manner.

15. The intermediate product according to claim 14, wherein the target rod comprises a first glass region, which is adjoined by the marker element, the marker element being preferably arranged between the first glass region and the cladding material layer and very preferably at least partially filling a recess in an outer surface of the target rod.
